(19) United States
(12) Patent Application Publication
(10) Pub. No.: US 2015/0199383 A1
(43) Pub. Date: Jul. 16, 2015

(54) Systems and Methods for Indexing and Retrieving Images

(71) Applicant: Nokia Corporation, Espoo (FI)

(72) Inventor: Kimmo T. Roimela, Tampere (FI)

(73) Assignee: Nokia Corporation, Espoo (FI)

(21) Appl. No.: 14/156,685

(22) Filed: Jan. 16, 2014

(51) Int. Cl. G06F 17/30

(52) U.S. Cl. CPC G06F 17/30256; G06F 17/30327

(57) ABSTRACT

Systems, apparatuses, and methods are provided for indexing and retrieving an image. A plurality of candidate images is received. The plurality of candidate images is analyzed, using a processor, for specified criteria. At least a portion of the plurality of candidate images that meet the specified criteria are indexed into at least one node of an octree database, thereby forming indexed image data. The database may be stored for offline use on a mobile device, personal computer, or workstation. Images may be retrieved for a specified geographic location or at least one oct-key identifier from the mobile device, personal computer, or workstation.

### FIELD

The following disclosure relates to indexing and rendering images, and, in particular methods and systems for globally indexing available geolocated images for efficient retrieval and visualization.

### BACKGROUND

The sheer volume of available geolocated images online makes it difficult or impossible to load all of the images onto a device's memory for efficient visualization. As three-dimensional (3D) visualization not only scales nearly infinitely, but also represents both large distant areas and small foreground details in the same view, it is difficult to predetermine a reasonable subset of images that will be enough to capture the detail available even in a small real-world area, while also providing a good overview of the entire small real-world area. Therefore, in an effort to render an image on a mobile device, a personal computer, or a workstation, in order to optimize network usage, there is a continuing effort to provide an efficient mechanism for determining a good set of indexed images before data is loaded over the air. Additionally, there is a continuing effort to provide an efficient mechanism for streaming in new data as the point of view or location is adjusted within the scene.

### SUMMARY

Systems, apparatuses, and methods are provided for indexing and retrieving images. In one embodiment, the method comprises receiving a plurality of candidate images. The method further comprises analyzing, using a processor, the plurality of candidate images for specified criteria. The method further comprises indexing at least a portion of the plurality of candidate images that meet the specified criteria into at least one node of an octree database, thereby forming indexed image data.

In another embodiment, the method comprises indexing a plurality of candidate images into a plurality of nodes of a global octree database. The method further comprises storing the global octree database onto a mobile device, a personal computer, or a workstation. The method further comprises accessing the global octree database offline from the mobile device, the personal computer, or the workstation. The method further comprises inputting a geographic location or at least one oct-key identifier on the mobile device, the personal computer, or the workstation. The method further comprises retrieving at least one stored image at the geographic location or associated with the at least one oct-key identifier from the global octree database.

In another embodiment, the apparatus comprises at least one processor and at least one memory including computer program code for one or more programs; the at least one memory and the computer program code configured to, with the at least one processor, cause the apparatus to at least perform: (1) receive a plurality of candidate images; (2) analyze the plurality of candidate images for specified criteria; and (3) index at least a portion of the plurality of candidate images that meet the specified criteria into at least one node to form indexed image data.

### BRIEF DESCRIPTION OF THE DRAWINGS

Exemplary embodiments are described herein with reference to the following drawings.

FIG. 1 illustrates an example of an octree data structure, or a portion of an octree data structure, having three tree levels.

FIG. 2 illustrates an example of a quadtree structure for a Mercator projection of the world.

FIG. 3 illustrates an example of a two-dimensional view frustum.

FIG. 4 illustrates an example of a three-dimensional city model image loaded and divided into smaller images according to octree nodes.

FIG. 5 illustrates an example flowchart for indexing image data in an octree data structure.

FIG. 6 illustrates an example image data system for indexing and retrieving images.

FIG. 7 illustrates an exemplary device of the system of FIG. 6.

FIG. 8 illustrates an exemplary server of the system of FIG. 6.

### DETAILED DESCRIPTION

The following embodiments include the systems, apparatuses, and methods for indexing geolocated or geotagged images for efficient retrieval and retrieving. In particular, the following embodiments allow for building a global three-dimensional index of photographs that can be used to accelerate searching, loading, and retrieving image data to represent any given part of our planet. The index may allow for high scalability of three-dimensional data, wherein the indexed images may comprise an octree data structure or database having multiple levels of detail ranging from full Earth down to sub-centimeter cubes. This is more than enough to allow not only outdoor, but also indoor imagery to be directly addressable using similar indexing systems, apparatuses, and methods.

By defining a global, virtual octree data structure or database that may cover the entire planet, the projected volumes of each geolocated image may be intersected with the octree nodes, and for each node, a short list of images may be obtained that represent that node well. Therefore, during retrieval or rendering on a mobile device, a personal computer, or a workstation, an end-user or renderer only needs to determine the set of visible octree nodes for the current view. Accessing online images for each node may become trivial.

An octree is a tree data structure most often used to partition a three-dimensional space by recursively subdividing it into eight octants or “nodes.” Octrees are generally the three-dimensional analog of a quadtree. In the octree, each node may contain a value or condition (e.g., the node may represent geometry of the world or it may represent an empty cell having no data). A node that has a child is called the child's “parent node.” An “inner node” or “branch node” refers to any node of the tree that has child nodes. The topmost node in the tree is called the “root node.” Additionally, a node that has no child nodes is referred to as a “terminal node.”

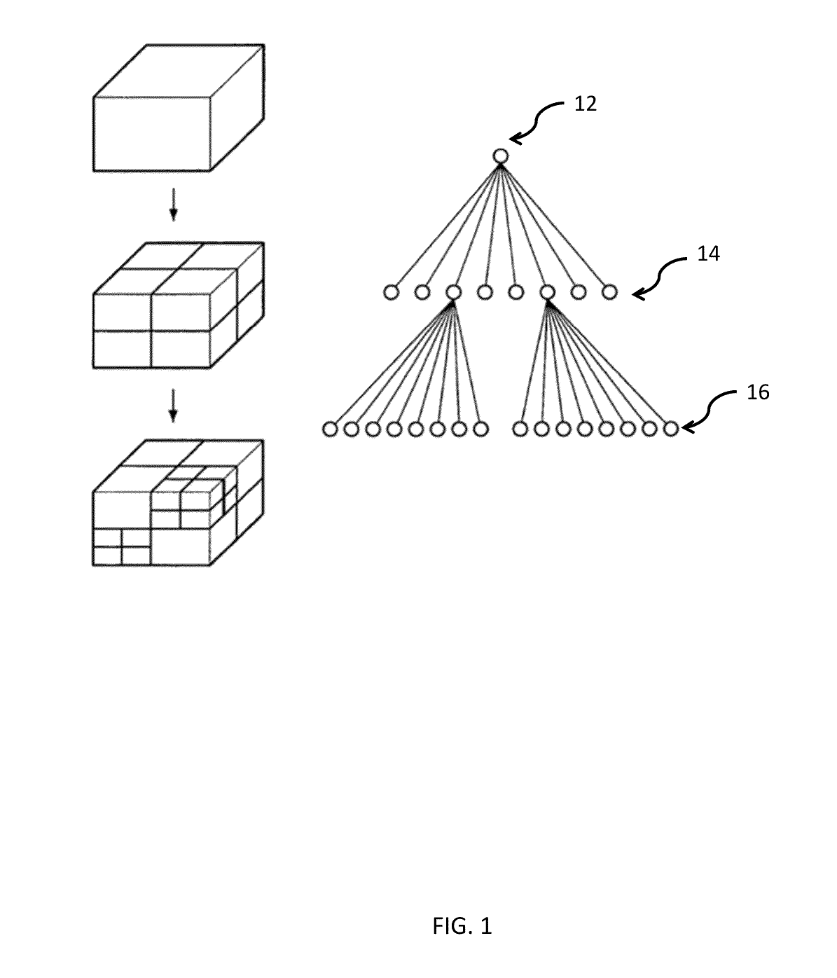

FIG. 1 illustrates an example of an octree data structure or database having three tree levels. The octree data structure begins with a first tree level 12 having a root node. The root node is divided into eight child nodes, shown on the second tree level 14. FIG. 1 further illustrates two nodes on the second tree level that are individually divided into eight child nodes of their own, shown on the third tree level 16.

In certain embodiments, the octree data structure represents a storage of indexed images at varying levels of detail for a particular segment or location of the world. In some embodiments, the octree data structure represents an indexed structure of images at varying levels of detail for the entire world, or at least a majority of the world.

The octree data structure for the world may be defined as a three-dimensional (3D) extension of the quadtree tiling structure used by map systems such as HERE or NAVTEQ for satellite imagery or map data. In certain embodiments, the quadtree structure is based on a spherical Mercator projection of the world, where the area between approximately 85° S and 85° N latitude. In other embodiments, the area between 82° S and 82° N latitude is projected onto a square. In some embodiments, based on the distortion of the Mercator projection of the world at the northern and southern extremities, the area between 70° S and 70° N latitude is projected onto a square.

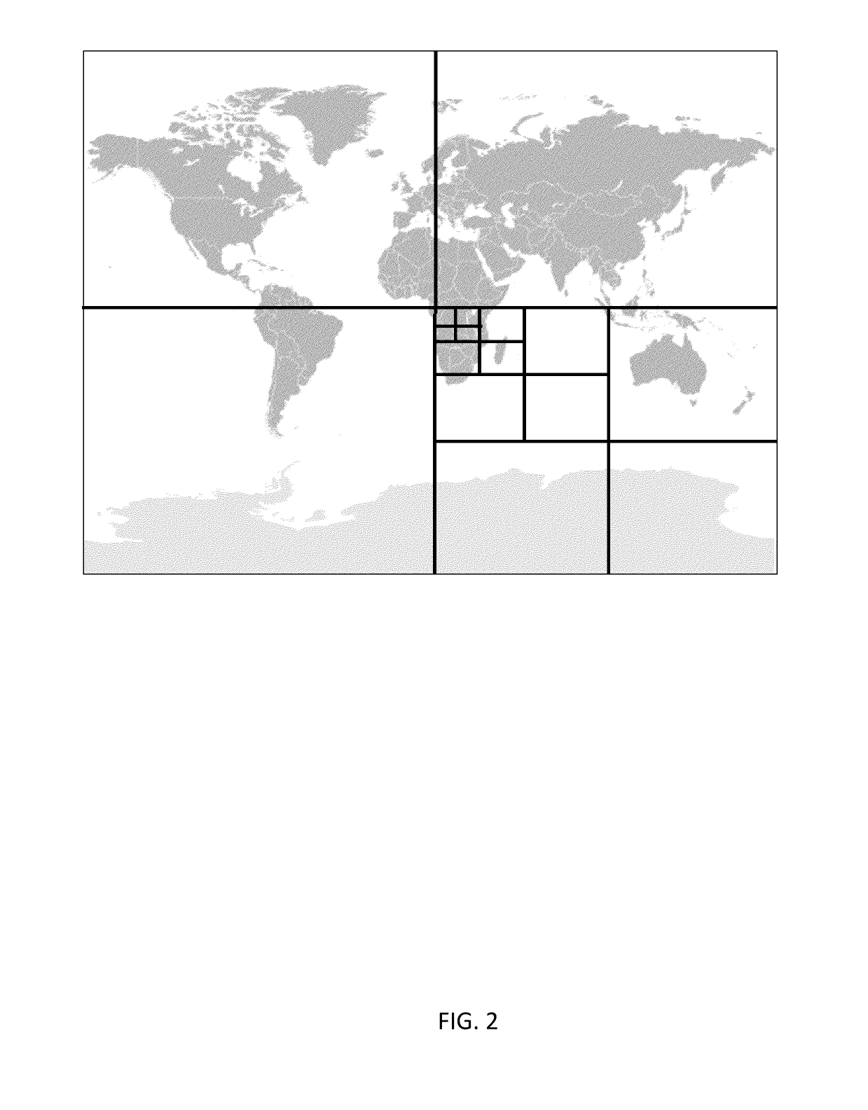

FIG. 2 illustrates an example of a quadtree structure for a Mercator projection of the world, wherein the root node (i.e., entire world) is recursively subdivided into four child nodes. In a quadtree structure, the root node for the world is recursively subdivided into four child squares at each successive tree level. The octree data structure may apply the longitude scaling used in the Mercator projection for elevations such that, by selecting a suitable range of elevations, the octree data structure may represent approximately uniformly shaped cube nodes. In some embodiments, such uniformly shaped nodes may allow certain optimizations when assigning images or calculating levels of detail for retrieval.

In certain embodiments, the octree data structure comprises at least 10 tree levels, at least 15 tree levels, at least 20 tree levels, at least 25 tree levels, or at least 30 tree levels. In certain embodiments, the octree data structure for the segment of the world has a number of tree levels necessary to create terminal nodes having dimensions in length, width, and height of approximately 30 cm, 20 cm, 10 cm, 5 cm, 2 cm, 1 cm, 0.5 cm, or 0.1 cm each. In one particular embodiment, the octree data structure comprises 32 tree levels for the world, wherein the terminal nodes have dimensions in length, width, and height of less than 1 cm each, between 0.5 cm and 1 cm each, or between 1 cm and 2 cm each.

With each node in the octree having eight children, indexed from 0 to 7, a path from the root node to any descendant node may be linked. Therefore, each node comprises unique, compact integer identifier or “oct-key identifier” having three bits per tree level. In certain embodiments, discussed in greater detail below, the oct-key identifier may be mapped to a uniform resource identifier (URI) on a content delivery network that may provide direct access to any data relevant to any given node.

Image source data or candidate images for analysis and potential storage in the octree data structure or database may be provided from a number of sources. In certain embodiments, candidate images are registered (i.e., copyrighted) two-dimensional digital photographs, publicly available two-dimensional digital photographs, or three-dimensional data of a particular geographic location. In other embodiments, the candidate images are captured by digital cameras specifically for developing the octree data structure (which may be helpful where the registered or publicly available digital photograph database is incomplete or potentially inaccurate). The candidate images may include metadata such as geographical identification metadata (i.e., “geolocated” or “geotagged” information). In some embodiments, the metadata comprises latitude and longitude coordinates, pose, focal length, focus distance, aperture, sensor size and aspect ratio, altitude, bearing, and/or accuracy data of the captured image.

The candidate images may be analyzed by a computer algorithm and potentially selected for indexing based on certain criteria, such as, but not limited to: (1) the presence of visible geometry within the octree node, (2) coverage of the entire node from a viewing position, (3) resolution of the candidate image, (4) visibility of the geometry from the viewing position, (5) occlusion of the geometry from the viewing position, and (6) image consistency of the visible geometry within the octree node.

### Visible Geometry

In certain embodiments, a candidate image may be indexed to an octree node if the image contains visible objects or geometry such as a building, scenery, or another object of interest inside the boundaries of the octree node. If a candidate image comprises no visible object or geometry, the algorithm may determine that no further analysis is needed, and may decide not to index the image within a database or client application for retrieval.

### Coverage of the Octree Node

In certain embodiments, the candidate image may be indexed to an octree node if the image covers the entire octree node. This may be determined by analyzing whether the bounding box of the octree node is completely inside a view frustum of the reconstructed camera for that image. For additional accuracy, the bounding box of the visible geometry within the octree node may be used instead. The view frustum may represent three-dimensional volume captured in a two-dimensional image. In certain embodiments, by calculating the intersection of the view frustum with the three-dimensional extents of each octree node in the relevant area, an algorithm can determine which octree nodes are intersected by the image.

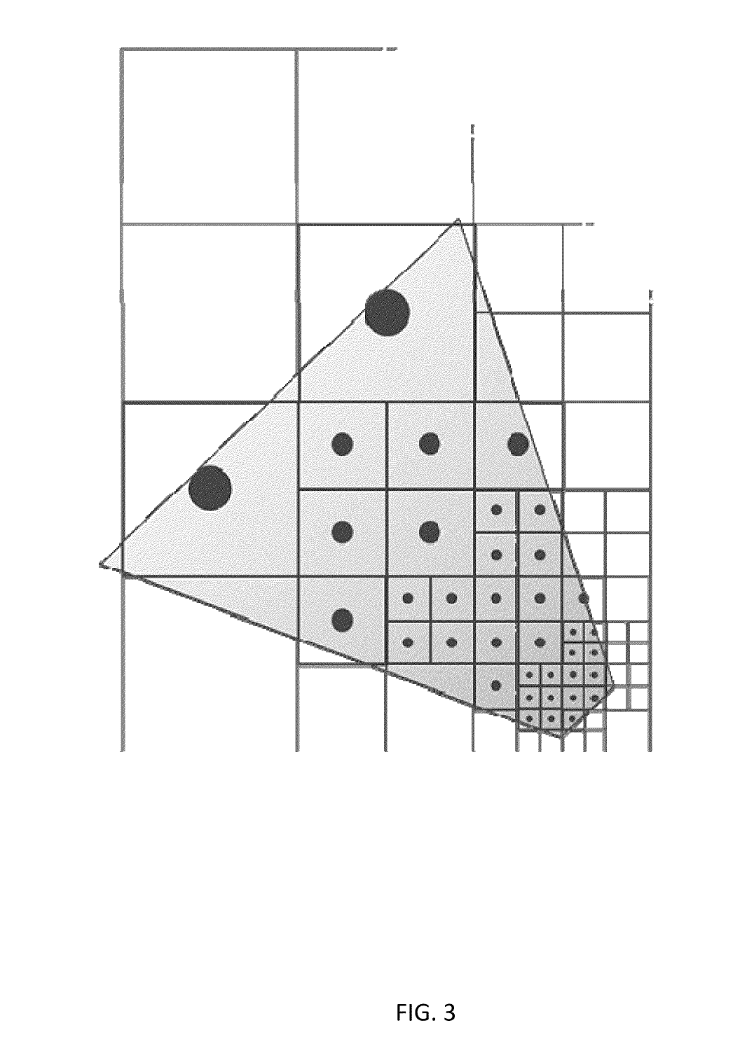

FIG. 3 illustrates an example of a view frustum, shown in two-dimensions for simplification. The shaded conical structure represents the view frustum and the black dots represent the various nodes being analyzed within the view frustum. In certain embodiments, the analysis involves determining whether the image is a good representation of the intersected node or not. In practice, the image volume can usually be optimized so that it covers as small a subset of the world as is meaningful: for example, when aligning the image using structure-from-motion techniques, we can determine the closest and farthest feature point matched in the image, and use those distances to cap the size of the image view frustum. Alternatively, we can estimate the depth of field of the image based on focus distance, aperture, and sensor size stored in camera metadata.

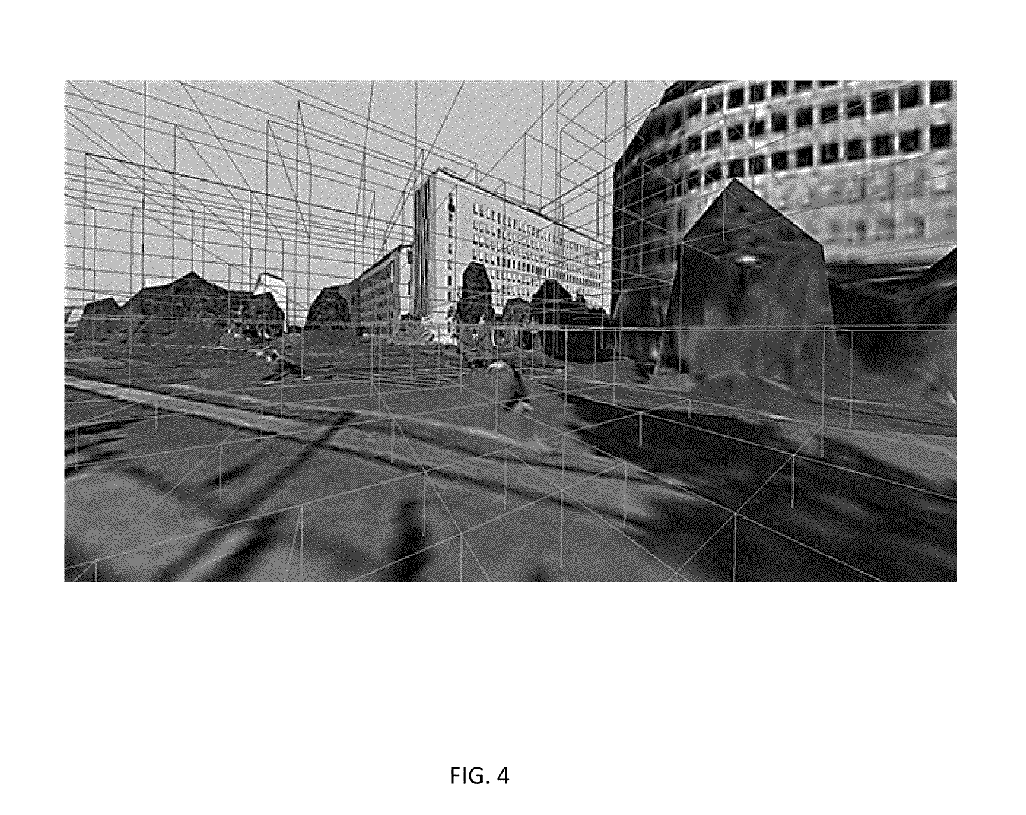

FIG. 4 illustrates an example of a three-dimensional city model image loaded and divided into smaller images according to octree nodes. The image may be analyzed for potential indexing, and metadata may be generated for each octree node. The analysis may include, for example, (1) determining whether the octree node is empty or whether the node contains geometry or a geographic structure, (2) what is the source and resolution of the geometry, and (3) which way the surfaces in the geometry are facing. Such metadata may be useful when building an index of images for a database.

As shown in FIG. 4, the process of dividing of an image into octree nodes may include forming smaller sized nodes in the direction of the camera location. In such an embodiment, the detail of the image is at a higher resolution and provides clear detail near the camera location. Larger nodes may store less detailed image for geographic structures located farther away from the camera location while still providing clear detail for the geographic structure.

### Resolution of the Candidate Image

Based on image dimensions and reconstructed camera parameters, an algorithm may compute projected minimum and maximum resolutions for each candidate image at a given node. In certain embodiments, the levels in the octree data structure correspond to different levels of detail, wherein a child level has a resolution that is at least two times greater than the resolution of the child's parent level. In practice, the octree data structure comprises some canonical resolution at each cell level so that the database or client application can reasonably compute a visible set of images without resorting to properties of per-cell data.

Therefore, in certain embodiments, a candidate image for a particular node may be indexed in the database or client application if the resolution of the particular image is above a minimum threshold to avoid rendering a blurry, low-resolution image for any node. Further, a candidate image for a particular node may be stored in the database or client application if the resolution of the particular image is below a maximum threshold, such that the image data does not consume more memory than needed to provide a clear, well-defined image. In some embodiments, a very high-resolution image is a poor match for indexing in the octree data structure. This may be solved in practice by either downsampling the high-resolution image when loaded for analysis, or splitting the high-resolution image into virtual tiles or child nodes which may be indexed more easily.

### Visibility of the Geometry

In certain embodiments, an algorithm may analyze the geometry and the surfaces of the geometry contained within each octree node. Each geometry surface may comprise normal vectors that indicate the direction the surface faces. Based on the normal vectors, an algorithm may determine a “visibility cone” or set of directions from which the surface may be viewed. Therefore, when determining candidate images for indexing and retrieval, the viewing direction or directions of the image may be determined based on whether or not the geometry surface is visible from the particular viewing direction. In other words, in order to view the geometry surface, the viewing direction of the reconstructed camera for the candidate image must fall within the visibility cone. In certain embodiments, if an algorithm determines that a particular geometry surface is not visible from a chosen viewing direction, the chosen viewing direction is not selected for indexing. Additionally, if the algorithm determines that the particular geometry surface is visible from a chosen viewing direction, the chosen viewing direction and the image at that viewing direction may be selected for indexing.

Occlusion of the Geometry from the Viewing Position

In certain embodiments, when determining a particular viewing direction for image indexing, an algorithm may determine whether there are any occlusions between the reconstructed camera's viewing direction and the geometry within the node being viewed. For a particular viewing direction of a chosen node, there should be no octree nodes occupied by geometry that are closer to the reconstructed camera than the chosen node. In certain embodiments, if an algorithm determines that a particular geometry surface in a node is not visible from a chosen viewing direction because it is occluded, the chosen viewing direction may not selected for indexing. Additionally, if the algorithm determines that the particular geometry surface is visible from a chosen viewing direction and is not occluded, the chosen viewing direction and the image at that viewing direction may be selected for indexing.

### Image Consistency of the Visible Geometry

In some embodiments, when determining a particular viewing direction for image indexing, an algorithm analyzes the various candidate images projected onto the octree node in question. Particular images may be chosen or excluded based on their compatibility or distinction with their surrounding images. For example, a particular image that includes an occluding objection or shows drastically different colors and textures from its surrounding images may be excluded from indexing.

### Selection of Images for Indexing

In certain embodiments, candidate images may be analyzed based on the criteria described above, along with potentially additional criteria, and a small subset of images may be selected and indexed. Due to a select, screened number of indexed images, a downstream process or end-user may efficiently select both the images to load and the images to retrieve or process for any given view. These indexed images may be stored online as metadata. In some embodiments, the indexed images may be loaded onto a mobile device, a personal computer, a workstation, or a client application for offline analysis. In certain embodiments, the index of images may be built and updated offline and maintained on a server. In some embodiments, the indexed images may be built or installed locally in a client application. Such offline analysis may allow for more extensive study of, e.g., occluded images, and may result in a higher-quality index.

In certain embodiments, the octree database containing the indexed images may be accessed by a mobile device, personal computer, or workstation. This process may be conducted for an operator or end-user to input a geographic location or at least one oct-key identifier, and retrieve at least one indexed image for the selected geographic location or the oct-key identifier. In certain embodiments, the geographic location may contain multiple viewing directions, wherein the end-user may select one or more of the desired viewing directions for retrieval. In some embodiments, the operator or end-user may also input viewing parameters with the geographic location or the at least one oct-key identifier for assisting in the retrieval of at least one indexed image. In some embodiments, the operator or end-user may input more than one oct-key identifier for assisting in the retrieval of at least one indexed image.

In certain embodiments, retrieval of the at least one indexed image is useful for rendering a specific image or images on the mobile device, personal computer, or workstation. In another embodiment, retrieval of the at least one indexed image is useful for quickly and efficiently pulling multiple photographs from a geographic area for further processing.

In other embodiments, retrieval of an indexed image is useful in an application for visual positioning or tracking of the mobile device, wherein the mobile device's camera view is matched with an indexed image from the octree database. In such an application, a retrieved indexed image includes metadata (e.g., latitude and longitude coordinates) allowing the mobile device's position to be tracked. In some embodiments, the tracking process is completed without reliance on a Global Positioning System (GPS) or Global Navigation Satellite System (GLONASS).

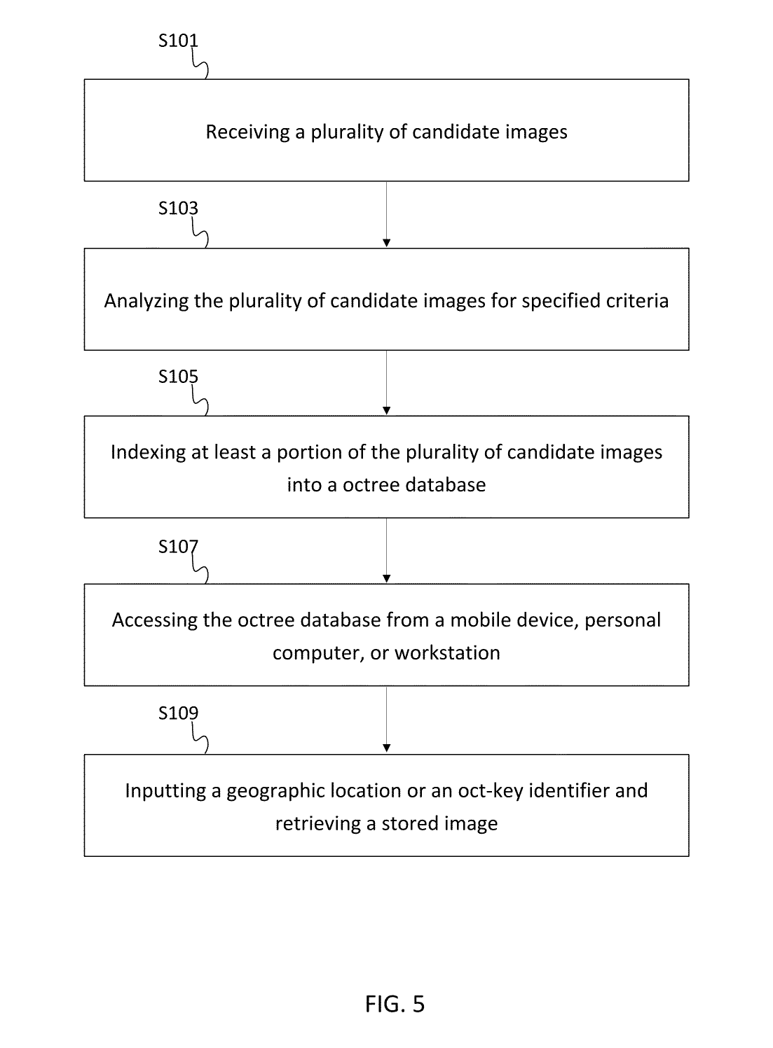

FIG. 5 illustrates an example flowchart for indexing and retrieving image data in an octree data structure. The process of the flowchart may be performed by a mobile device or personal computer and controller and/or server and processor. Alternatively, another device may be configured to perform one or more of the following acts. Additional, fewer, or different acts may be included.

At act S101, a plurality of candidate images (i.e., more than one image) or image source data is received for analysis. The image source data or candidate images may be provided from a number of sources such as registered or publicly available two-dimensional digital photographs or three-dimensional data of a particular geographic location. The candidate images may include metadata such as geographical identification metadata such as latitude and longitude coordinates, pose, focal length, focus distance, aperture, sensor size and aspect ratio, altitude, bearing, and/or accuracy data.

At act S103, the candidate images are analyzed by a computer algorithm and potentially selected for indexing based on specified criteria, such as, but not limited to: (1) whether an individual image in the plurality of candidate images includes visible geometry within the at least one node, (2) whether the at least one node is included in its entirety from a selected viewing position, (3) whether the individual image includes a minimum projected image resolution, (4) whether the visible geometry within the at least one node is visible from the selected viewing position, (5) whether there is an occlusion of the visible geometry from the selected viewing position, (6) whether the projection of the candidate image on the visible geometry within the at least one node is consistent in characteristics with projections of surrounding images of the visible geometry, and (7) combinations thereof.

At act S105, at least a portion of the plurality of candidate images that meet the specified criteria are indexed into at least one node of an octree database, thereby forming indexed image data. In certain embodiments, a small subset of the candidate images for a particular node or nodes are selected and indexed. Due to a select, screened number of indexed images, an end-user or renderer may efficiently select both the images to load and the images to retrieve for any given view. These indexed images may be stored online as metadata or the indexed images may be loaded onto a mobile device, a personal computer, a workstation, or a client application for offline analysis.

At act S107, the octree database containing the indexed images may be accessed by a mobile device, personal computer, or workstation. This process may be conducted for an end-user to retrieve an image for a selected geographic location or at least one oct-key identifier.

At act S109, an end-user may input a selected geographic location and retrieve at least one stored image for the geographic location or the at least one oct-key identifier. In certain embodiments, the geographic location or the at least one oct-key identifier may contain multiple viewing directions, wherein the end-user may select one or more of the desired viewing directions for retrieval.

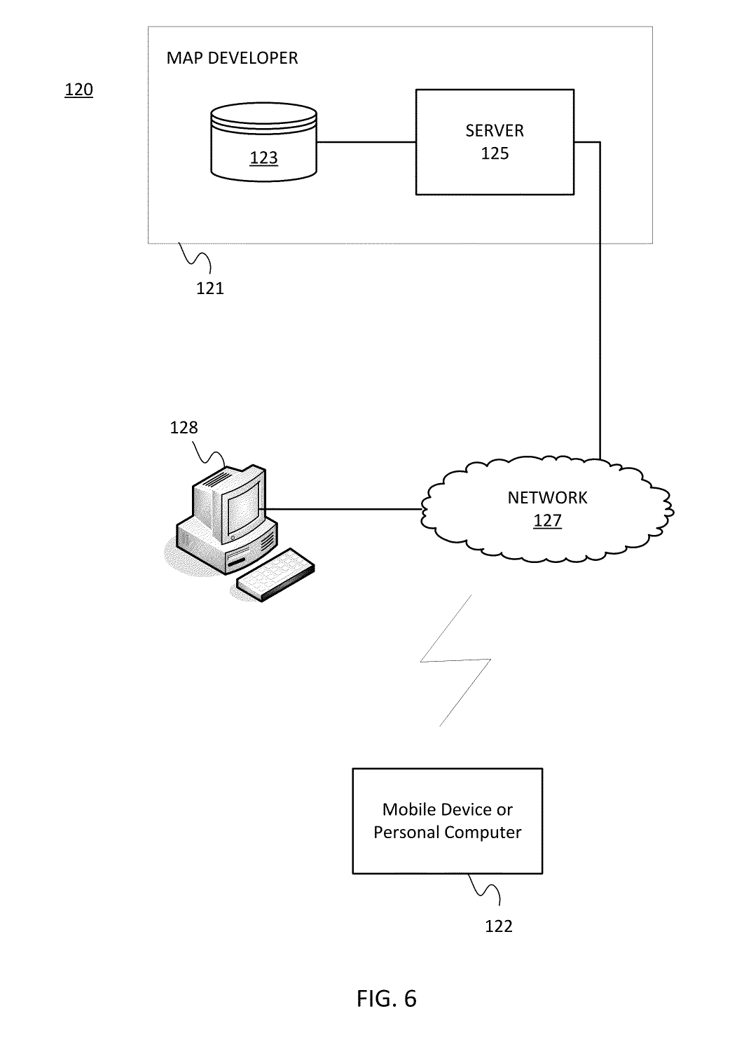

As discussed above, indexing and retrieving an image may be performed by a mobile device or personal computer and controller and/or server and processor. FIG. 6 illustrates one embodiment of an image data system for indexing and retrieving images 120. The system 120 may include an octree database developer system 121, a mobile device or personal computer 122, a workstation 128, and a network 127. Additional, different, or fewer components may be provided.

The mobile device or personal computer 122 may be a smart phone, a mobile phone, a personal digital assistant (“PDA”), a tablet computer, a notebook computer, a desktop computer, a personal navigation device (“PND”), a portable navigation device, and/or any other known or later developed mobile device or personal computer.

The developer system 121 includes a server 125 and a database 123. The developer system 121 may include computer systems and networks of a system operator such as HERE, NAVTEQ or Nokia Corporation. The database 123 is configured to indexed images for the various octree nodes. The server 125 is configured to receive candidate, geotagged images for analysis and indexing.

The developer system 121, the workstation 128, and the mobile device or personal computer 122 are coupled with the network 127. The phrase “coupled with” is defined to mean directly connected to or indirectly connected through one or more intermediate components. Such intermediate components may include hardware and/or software-based components.

The workstation 128 may be a general purpose computer including programming specialized for providing input to the server 125. For example, the workstation 128 may provide settings for the server 125. The settings may include a value for the predetermined interval that the server 125 requests mobile device 122 to relay current geographic locations. The workstation 128 may be used to enter data indicative of GPS accuracy to the database 123. The workstation 128 may include at least a memory, a processor, and a communication interface.

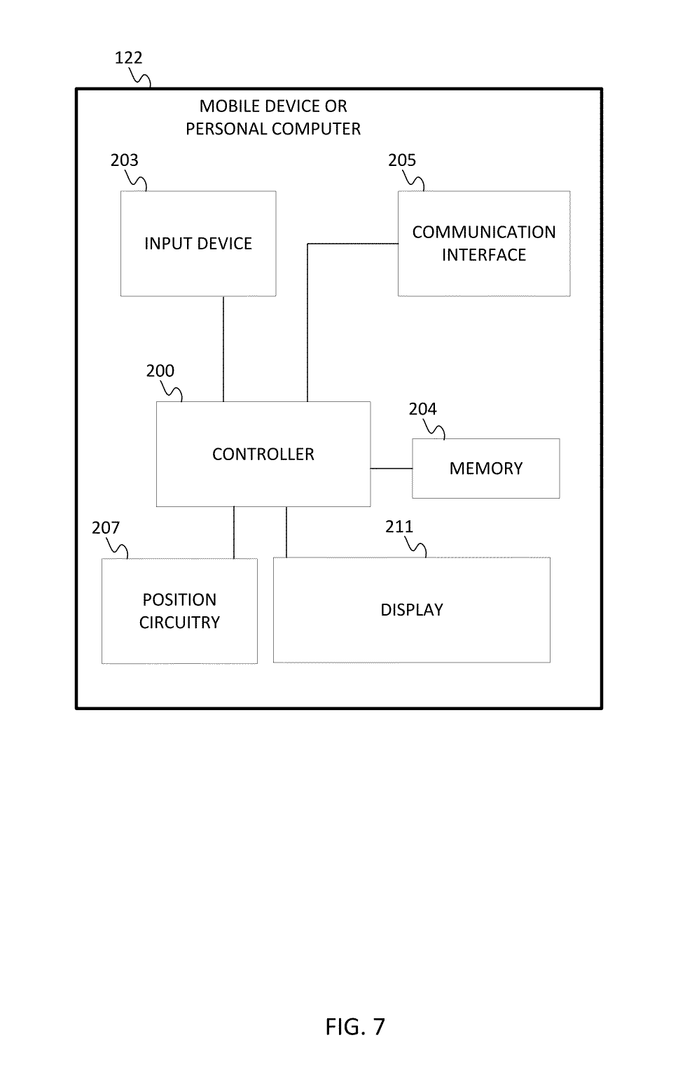

FIG. 7 illustrates an exemplary mobile device or personal computer 122 of the system of FIG. 6. The mobile device or personal computer 122 includes a controller 200, a memory 204, an input device 203, a communication interface 205, position circuitry 207, and a display 211. Additional, different, or fewer components are possible for the mobile device/personal computer 122.

The controller 200 may be configured to receive data indicative of the location of the mobile device 122 from the position circuitry 207. The positioning circuitry 207, which is an example of a positioning system, is configured to determine a geographic position of the mobile device 122. The positioning circuitry 207 may include sensing devices that measure the traveling distance, speed, direction, and so on, of the mobile device 122. The positioning system may also include a receiver and correlation chip to obtain a GPS signal. The positioning circuitry may include an identifier of a model of the positioning circuitry 207. The controller 200 may access the identifier and query a database or a website to retrieve the accuracy of the positioning circuitry 207 based on the identifier. The positioning circuitry 207 may include a memory or setting indicative of the accuracy of the positioning circuitry.

Alternatively or additionally, the one or more detectors or sensors in the positioning circuitry 207 may include an accelerometer and/or a magnetic sensor built or embedded into or within the interior of the mobile device 122. The positioning circuitry 207 may include a Global Positioning System (GPS), Global Navigation Satellite System (GLONASS), or a cellular or similar position sensor for providing location data.

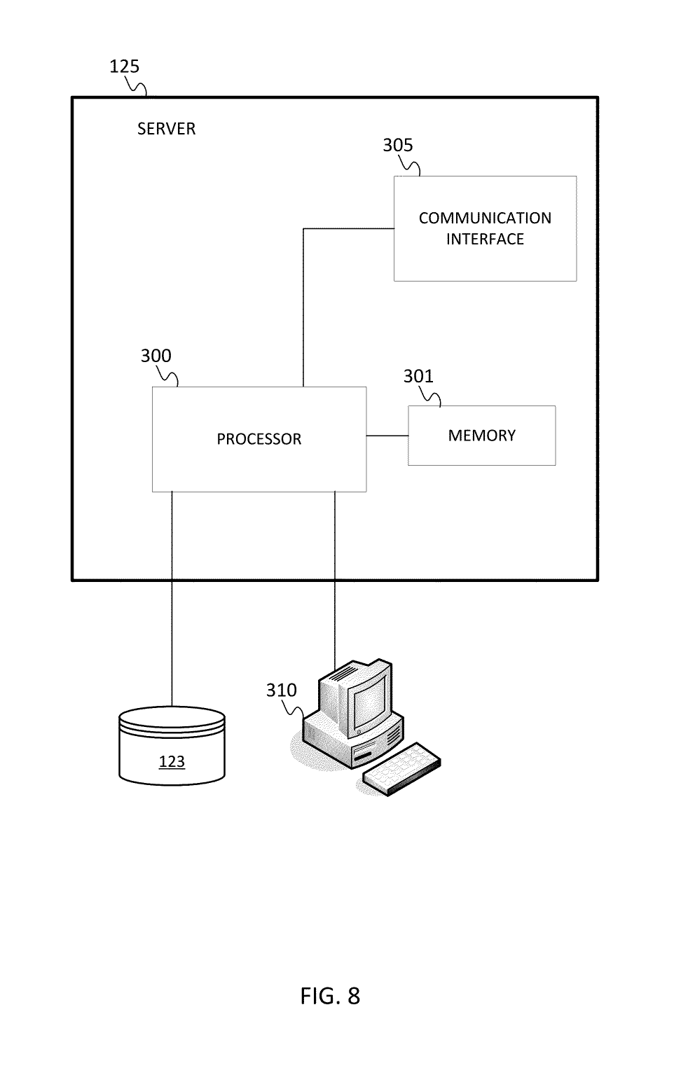

FIG. 8 illustrates an exemplary server 125 of the image data system of FIG. 6. The server 125 includes a processor 300, a communication interface 305, and a memory 301. The server 125 may be coupled to a database 123 and a workstation 128. The workstation 128 may be used as an input device for the server 125. In addition, the communication interface 305 is an input device for the server 125. The communication interface 305 receives data indicative of use inputs made via the workstation 128 or the mobile device or personal computer 122.

The controller 200 and/or processor 300 may include a general processor, digital signal processor, an application specific integrated circuit (ASIC), field programmable gate array (FPGA), analog circuit, digital circuit, combinations thereof, or other now known or later developed processor. The controller 200 and/or processor 300 may be a single device or combinations of devices, such as associated with a network, distributed processing, or cloud computing.

The controller 200 and/or processor 300 may also be configured to cause an apparatus to at least perform at least one of the indexing methods described above. For example, the controller 200 and/or processor 300 may be configured to perform one or more of the process of: (1) receiving a plurality of candidate images (i.e., more than one image) or image source data for analysis; (2) analyzing the candidate images for specified criteria; (3) indexing at least a portion of the plurality of candidate images that meet the specified criteria into at least one node of an octree database; (4) accessing the octree database by a mobile device, personal computer, or workstation; and (5) inputting a selected geographic location or at least one oct-key identifier and retrieving at least one stored image from the octree database. In certain embodiments, the geographic location or the at least one oct-key identifier may contain multiple viewing directions, wherein the controller 200 and/or processer 300 may select one or more of the desired viewing directions for retrieval.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 301 may be removable from the mobile device 122, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

In the above described embodiments, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A method comprising:
receiving a plurality of candidate images;
analyzing, using a processor, the plurality of candidate images for specified criteria; and
indexing at least a portion of the plurality of candidate images that meet the specified criteria into at least one node of an octree database, thereby forming indexed image data.

2. The method of claim 1, wherein the specified criteria includes: (1) whether an individual image in the plurality of candidate images includes visible geometry within the at least one node, (2) whether the at least one node is included in its entirety from a selected viewing position, (3) whether the individual image includes a minimum projected image resolution, (4) whether the visible geometry within the at least one node is visible from the selected viewing position, (5) whether there is an occlusion of the visible geometry from the selected viewing position, (6) whether a projection of the candidate image on the visible geometry within the at least one node is consistent in characteristics with projections of surrounding images of the visible geometry, and (7) combinations thereof.

3. The method of claim 1, further comprising storing the indexed image data onto a mobile device, a personal computer, or a workstation.

4. The method of claim 1, further comprising maintaining the indexed image data on a server.

5. The method of claim 1, wherein the plurality of candidate images comprise registered or publicly available two-dimensional digital photographs.

6. The method of claim 1, wherein the plurality of candidate images comprise metadata selected from the group consisting of: latitude and longitude coordinates, pose, focal length, focus distance, aperture, sensor size, aspect ratio, altitude, bearing, accuracy data, and combinations thereof.

7. The method of claim 1, wherein the octree database is a global octree database incorporating the indexed image data for a majority of octree nodes for a Mercator projection of Earth between 70° S and 70° N latitude.

8. The method of claim 7, wherein the global octree database comprises at least 30 tree levels.

9. The method of claim 7, further comprising:
accessing the global octree database from a mobile device, a personal computer, or a workstation;
inputting a geographic location or at least one oct-key identifier on the mobile device, the personal computer, or the workstation; and
retrieving at least one stored image from the global octree database.

10. The method of claim 1, wherein indexed image data comprises both indoor and outdoor images.

11. An apparatus comprising:
at least one processor; and
at least one memory including computer program code for one or more programs;
the at least one memory and the computer program code configured to, with the at least one processor, cause the apparatus to at least perform:
receive a plurality of candidate images;
analyze the plurality of candidate images for specified criteria; and
index at least a portion of the plurality of candidate images that meet the specified criteria into at least one node to form indexed image data.

12. The apparatus of claim 11, wherein the specified criteria includes: (1) whether an individual image in the plurality of candidate images includes visible geometry within the at least one node, (2) whether the at least one node is included in its entirety from a selected viewing position, (3) whether the individual image includes a minimum projected image resolution, (4) whether the visible geometry within the at least one node is visible from the selected viewing position, (5) whether there is an occlusion of the visible geometry from the selected viewing position, (6) whether the projection of the candidate image on the visible geometry within the at least one node is consistent in characteristics with projections of surrounding images of the visible geometry, and (7) combinations thereof.

13. The apparatus of claim 11, wherein the at least one memory and the computer program code are configured to cause the apparatus to further perform:
store the indexed image data onto a mobile device, a personal computer, or a workstation.

14. The apparatus of claim 11, wherein the plurality of candidate images comprise registered or publicly available two-dimensional digital photographs.

15. The apparatus of claim 11, wherein the plurality of candidate images comprise metadata selected from the group consisting of: latitude and longitude coordinates, pose, focal length, focus distance, aperture, sensor size, aspect ratio, altitude, bearing, accuracy data, and combinations thereof.

16. The apparatus of claim 11, wherein the at least one memory and the computer program code are configured to cause the apparatus to further perform:
form a global octree database with the indexed image data, wherein the global octree database incorporates the indexed image data for a majority of octree nodes for a Mercator projection of Earth between 70° S and 70° N latitude.

17. The apparatus of claim 16, wherein the global octree database comprises at least 30 tree levels.

18. The apparatus of claim 16, wherein the at least one memory and the computer program code are configured to cause the apparatus to further perform:
access the global octree database from a mobile device, a personal computer, or a workstation;
input a geographic location or at least one oct-key identifier on the mobile device, the personal computer, or the workstation; and
retrieving at least one stored image from the global octree database.

19. The apparatus of claim 11, wherein indexed image data comprises both indoor and outdoor images.

20. A method comprising:
indexing a plurality of candidate images into a plurality of nodes of a global octree database;
storing the global octree database onto a mobile device, a personal computer, or a workstation;
accessing the global octree database offline from the mobile device, the personal computer, or the workstation;
inputting a geographic location or at least one oct-key identifier on the mobile device, the personal computer, or the workstation; and
retrieving at least one stored image from the global octree database.
